(19) United States
(12) Patent Application Publication
(10) Pub. No.: US 2005/0132946 A1
(43) Pub. Date: Jun. 23, 2005

(54) Repeatable fluid indicator assembly

(76) Inventors: Warren C. Maurer, Oxford, MI (US); Randall F. Alder, Fenton, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/745,032

(22) Filed: Dec. 23, 2003

(51) Int. Cl. G01F 23/04

(52) U.S. Cl. 116/227

(57) ABSTRACT

A fluid indicator assembly comprising an indicator tube having an upper portion and a lower portion. A stop associated with the indicator tube is defined by the transition from the upper portion to the lower portion of the indicator tube. An indicator stick is removably disposed within the indicator tube. The indicator stick has an upper portion and a lower portion. A stop associated with the indicator stick is defined by the transition from the upper portion to the lower portion of the indicator stick. The stop in the indicator tube and the stop in the indicator stick are proximate a fluid sump. It is emphasized that this abstract is provided to comply with the rules requiring an abstract that will allow a searcher or other reader to quickly ascertain the subject matter of the technical disclosure. This abstract is submitted with the understanding that it will not be used to interpret or limit the scope or meaning of the claims. 37 CFR 1.72(b).

### TECHNICAL FIELD

The present invention relates to indicator assemblies used to measure fluid levels, and in particular to an oil level indicator assembly for motor vehicle engines and transmissions.

### BACKGROUND OF THE INVENTION

Indicator sticks for checking the level of fluids in an operational environment, for example, engine oil within a vehicle engine or transmission oil within a transmission, are removably disposed within an indicator tube. The indicator sticks are typically a single narrow strip of steel with a proximate end and a distal end. The proximate end has a handle by which the indicator stick is inserted into and removed from the indicator tube, and a seal, which provides a retaining force for the indicator stick. The seal of the indicator tube serves as a stop for the indicator stick, limiting the travel of the indicator stick into a fluid sump. The distal end is immersed in the fluid sump holding fluid whose level is being checked and extends into the fluid without contacting any positive stop. The distal end has marks intended to indicate such things as indicating a full level of fluid and a low level of the fluid. Locations of the marks are dependent on the nominal values for the lengths of the indicator stick and the indicator tube, respectively, the point of contact between the indicator stick and the indicator tube, the relative location of the indicator tube to the engine or transmission block with which the indicator tube is associated, and the relative location of the engine block to a fluid sump. Any variations of these values from their nominal values can produce indicator stick readings that do not accurately reflect the true fluid level in the fluid sump.

However, the design of fluid indicator assemblies have inherent variances due to dimensional tolerances that must be added to the nominal values. Tolerance values increase as the number of components in a system increase and as the complexity between the interaction of the components increases. For example, with an engine oil indicator assembly, tolerances must be accounted from the point of contact between the indicator stick and the indicator tube to the fluid level indication marking on the indicator stick, and from the point of contact between the indicator stick and the indicator tube to where the indicator tube contacts the engine block. Moreover, tolerance must be added to the length of the indicator stick to take into consideration any bends in the indicator tube, the dimensions of the mating components such as an engine block, the dimensions of any gaskets associated with the mating components and the distance from the bottom of the gasket to the bottom of the fluid sump. Since these tolerances are cumulative, the positioning relationship between the indicator stick and the surface of the fluid is subject to a great amount of variation. Thus, conventional fluid indicator assemblies do not accurately and consistently read the proper fluid levels within the fluid sump. As a result, fluid levels may be overfilled or underfilled, depending upon the inaccurate reading of the indicator stick.

### SUMMARY OF THE INVENTION

The present invention relates to a fluid indicator assembly comprising an indicator tube having an upper portion and a lower portion. A stop associated with the indicator tube is defined by the transition from the upper portion to the lower portion of the indicator tube. An indicator stick is removably disposed within the indicator tube. The indicator stick has an upper portion and a lower portion. A stop associated with the indicator stick is defined by the transition from the upper portion to the lower portion of the indicator stick. The stop in the indicator tube and the stop in the indicator stick are proximate a fluid sump.

### BRIEF DESCRIPTION OF THE DRAWINGS

The present invention will now be described, by way of example, with reference to the accompanying drawings, in which:

FIG. 1 is a side view of a fluid indicator assembly in an engine according to the present invention within an engine.

FIG. 2 is a side view of the fluid indicator assembly according to the present invention.

FIG. 2A is a cross-sectional view of the fluid indicator assembly taken along line 2A-2A according to the present invention.

FIG. 2B is a cross-sectional view of an alternate embodiment of the fluid indicator assembly taken along line 2A-2A according to the present invention.

FIG. 3 is an exploded side view of two stop features of the fluid indicator assembly according to the present invention shown by the encircled region of FIG. 2.

FIG. 4 is an exploded side view of alternate stop features of the fluid indicator assembly according to the present invention.

FIG. 5 is an exploded side view of further alternate stop features of the fluid indicator assembly according to the present invention.

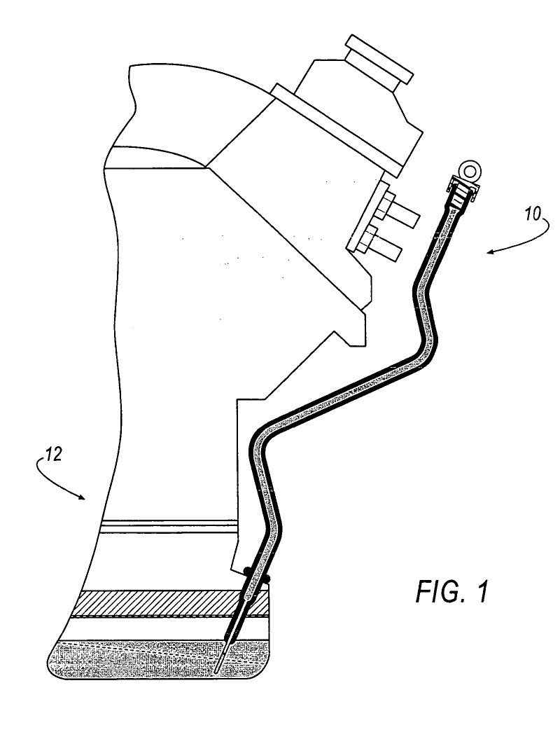

### DESCRIPTION OF THE PREFERRED EMBODIMENT

Referring to the Figures, a fluid indicator assembly 10 is generally shown installed within an operable environment, such as a vehicle engine block 12. The fluid indicator assembly 10 measures the fluid level, shown as a dashed line X, of a fluid 14 within a fluid sump 16. The fluid indicator assembly 10 includes an indicator stick 18 and an indicator tube 20. The indicator stick 18 is removably disposed within the indicator tube 20. The indicator stick 18 is a flexible material, such as a flexible blade, cable, or the like, and is substantially linear prior to being inserted into the indicator tube 20. Preferably, the indicator stick 18 is made from a flexible metal. While the fluid indicator assembly 10 of the present invention is directed towards measuring the fluid level of engine oil, it should be noted that the present invention may be practiced to measure the fluid level of other fluids in a vehicle, for example, the transmission fluid level of a transmission.

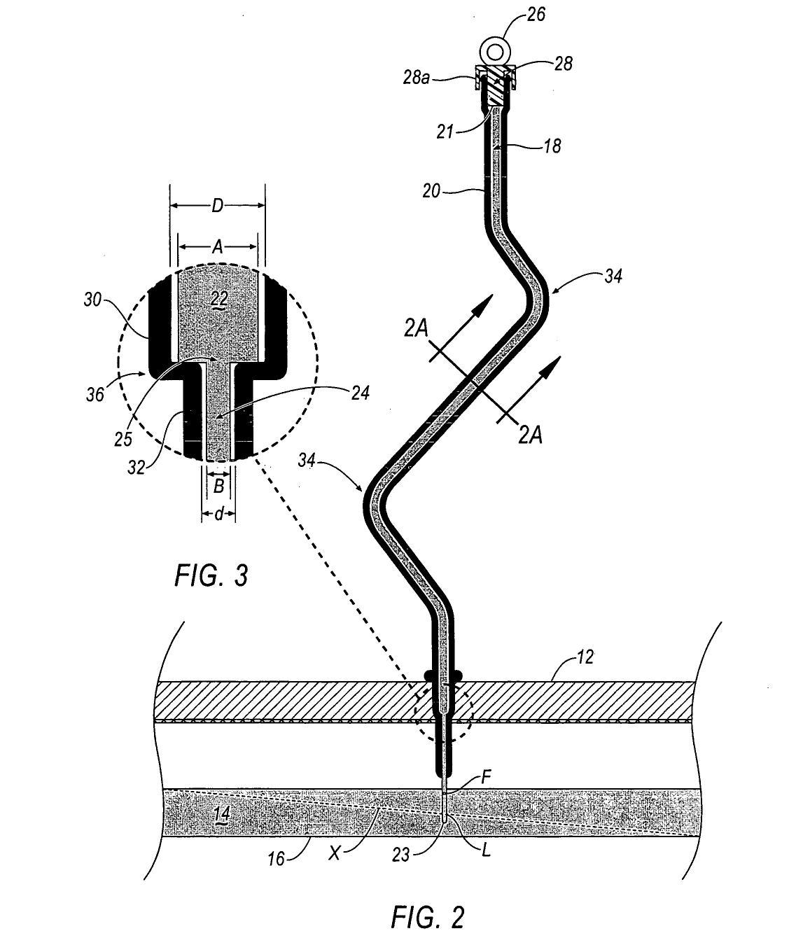

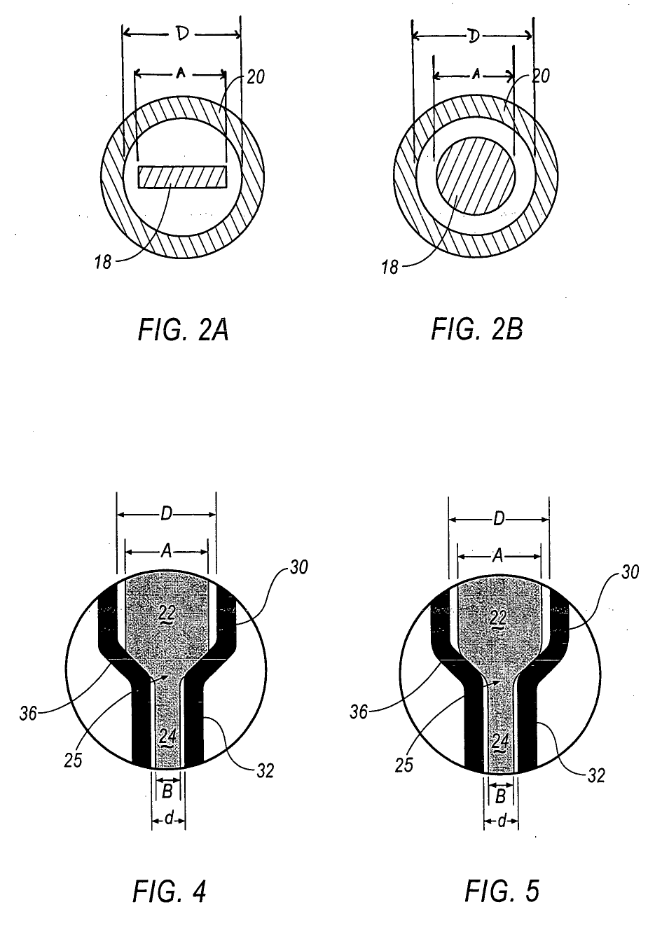

The indicator stick 18 includes an upper portion 22 and a lower portion 24. The upper portion 22 includes a means for removal of the indicator stick 18 from the indicator tube 20 adjacent a proximate end 21. As illustrated in FIG. 2, the means for removal of the indicator stick 18 is a handle 26. The upper portion 22 further includes a seal 28 adjacent handle 26. When indicator stick 18 is properly disposed within indicator tube 20, seal 28 engages the interior of indicator tube 20 and provides a retaining force against indicator tube 20. Additionally, seal 28 restricts the exit of fluid 14 from the indicator tube 20 by a lip 28a that sealingly engages the outer periphery of indicator tube 20. It should be noted that while seal 28 and lip 28a sealingly engage indicator tube 20, seal 28 and lip 28a do not limit the travel of indicator stick 18 within indicator tube 20, in contrast to the teachings of the prior art. The lower portion 24 further includes markings indicating such things as a full level of fluid F and a low level of fluid L within the fluid sump 16. Lower portion 24 terminates at a distal end 23 that is intended to contact fluid 14 within fluid sump 16.

As best illustrated in FIGS. 3-5, upper portion 22 of indicator stick 18 has a diameter or a width A and lower portion 24 has a diameter or a width B. Width A is greater than width B. The transition between upper portion 22 and lower portion 24 defines a stop feature 25 of indicator stick 18. As best shown in the illustrations, stop feature 25 is proximate the fluid sump 16. In the embodiment of FIG. 3, the transition from upper portion 22 to lower portion 24 is in the form of a step, or a square geometry, or the like. Alternatively, the transition from dimension A to dimension B may be more gradual. As illustrated in FIG. 4, upper portion 22 gradually tapers at an angle into lower portion 24. In a further alternative embodiment, the transition from upper portion 22 to lower portion 24 may be more fluid. FIG. 5 illustrates the transition from upper portion 22 flowing continuously into lower portion 24. It should be noted that FIGS. 3-5 are for purposes of illustration only, and stop feature 25 of indicator stick 18 may be of any desired configuration so long as dimension A of upper portion 22 is greater than dimension B of lower portion 24.

Indicator tube 20 receives indicator stick-18. Typically, indicator stick 18 is a flat bar and indicator tube 20 is a hollow cylindrical tube, best shown in the cross section illustrated in FIG. 2A. However, indicator stick 18 and indicator tube 20 may have complementary geometries, as illustrated in FIG. 2B. It can be appreciated that indicator stick 18 and indicator tube 20 may be of any desired geometry so long as indicator tube 20 is able to receive indicator stick 18.

Indicator tube 20 has an upper portion 30 and a lower portion 32. There are S-bends 34 in the indicator tube 20, both in upper portion 30 and in lower portion 32. During insertion, indicator stick 18 conforms to bends 34 in indicator tube 20. The bends 34 aid in centering the indicator stick 18 relative to the indicator tube 20.

Upper portion 30 of indicator tube 20 has an internal diameter or width D that is greater than a corresponding internal diameter or width d of lower portion 34. Width D is greater than width A while width d is greater than width B. A stop feature 36 is defined by the transition between upper portion 30 and lower portion 32. As with stop feature 25, stop feature 36 of indicator tube 20 is also proximate the fluid sump 16. As illustrated in FIGS. 3-5, stop feature 36 of indicator tube 20 generally follows the geometry of stop feature 25 of indicator stick 18. Accordingly, there may be a substantially sharp transition, a gradual tapering or a generally fluid transition between upper portion 30 and lower portion 34 of indicator tube 20. When indicator stick 18 is inserted into indicator tube 20, stop feature 25 of indicator stick 18 engages stop feature 36 of indicator tube 20. The interaction between stop feature 25 of indicator stick 18 and stop feature 36 of indicator tube 20 provides a point of contact between indicator stick 18 and indicator tube 20 that is proximate to fluid 14 in the fluid sump 16. It should be noted that stop features 25 and 36 may be of any desired shape, so long as stop features 25 and 36 have complimentary geometries that provide engagement to limit the travel of the indicator stick 18 into fluid sump 16. As stated above, it should be noted that when indicator stick 18 is properly disposed within indicator tube 20, seal 28 and lip 28a do not prohibit stop features 25 and 36 from engaging. In essence, the engagement of stop features 25 and 36 limit the travel of indicator stick 18 within indicator tube 20.

The fluid indicator assembly 10 of the present invention has advantages over conventional fluid indicator assemblies. For example, fluid indicator assembly 10 has a reduced tolerance stack up because (i) the number of components that comprise the tolerance stack up is reduced and (ii) the complexity of the interaction between different components is minimized. Specifically, the fluid indicator assembly 10 of the present invention does not have to include additional tolerance values for the interaction between the S-bends 34 of the indication tube 20 and the corresponding bends in the indicator stick 18. Also, any tolerance associated with the interaction between seal 28 and indicator tube 20 is not included in the tolerance stack up because the point of contact between indicator stick 18 and indicator tube 20 is proximate fluid sump 16. Thus, indicator stick 18, indicator tube 20 and seal 28 have a reduced effect in the tolerance stack up of the present invention. Therefore, the fluid indicator assembly 10 more accurately measures the true level of fluid and the. repeatability and corresponding accuracy of the fluid level readings of fluid indicator assembly 10 is greater than with conventional fluid indicator assemblies.

It should be understood that the aforementioned and other various alternatives to the embodiments of the invention described herein may be employed in practicing the invention. It is intended that the following claims define the scope of the invention and that the method and apparatus within the scope of these claims and their equivalents be covered thereby.

1. A fluid indicator assembly comprising:
an indicator tube having an upper portion and a lower portion, the indicator
tube including a width D in the upper portion and a width d in the lower portion;
a stop in the indicator tube, defined by the transition from the upper portion to
the lower portion of the indicator tube;
an indicator stick removably disposed within the indicator tube, the indicator
stick having an upper portion and a lower portion, the indicator stick including
a width A in the upper portion and a width B in the lower portion; and
a stop in the indicator stick, defined by the transition from the upper portion to
the lower portion of the indicator stick,
wherein the stop in the indicator tube and the stop in the indicator stick are proximate a fluid sump.

2. A fluid indicator assembly as in claim 1, wherein width A is greater than width B, and width D is greater than width d.

3. A fluid indicator assembly as in claim 1, wherein width D is greater than width A, and width d is greater than width B.

4. A fluid indicator assembly as in claim 1, wherein the lower portion of the indicator stick includes a distal end proximate the fluid sump, the distal end having a fluid indicating mechanism for measuring the level of a fluid in the fluid sump.

5. A fluid indicator assembly as in claim 1, wherein the upper portion of the indicator stick includes a proximate end, the proximate end having a seal.

6. A fluid indicator assembly as in claim 1, wherein the stop of the indicator stick selectively engages the stop of the indicator tube when the indicator stick is disposed within the indicator tube.

7. A fluid indicator assembly as in claim 5, wherein the seal of the upper portion of the indicator stick will not prohibit the stop of the indicator stick to selectively engage the stop of the indicator tube.

8. A fluid indicator assembly comprising:
an indicator tube having an upper portion and a lower portion, the indicator tube having at least one bend formed therein;
a stop in the indicator tube, the stop defined by the transition from the upper portion to the lower portion of the indicator tube;
an indicator stick removably disposed within the indicator tube; and
a stop in the indicator stick, the stop defined by the transition from the upper portion to the lower portion of the indicator stick,
wherein the stop in the indicator tube and the stop in the indicator stick are proximate a fluid sump.

9. A fluid indicator assembly as in claim 8, wherein the stop of the indicator stick selectively engages the stop of the indicator tube when the indicator stick is disposed within the indicator tube.

10. A fluid indicator assembly as in claim 9, wherein the upper portion of the indicator stick includes a proximate end, the proximate end having a seal.

11. A fluid indicator assembly as in claim 10, wherein the seal of the upper portion of the indicator stick will not prohibit the stop of the indicator stick to selectively engage the stop of the indicator tube.

12. A fluid indicator assembly as in claim 8, wherein the lower portion of the indicator stick includes a fluid indicating portion for measuring the level of a fluid in the fluid sump.

13. A fluid indicator assembly comprising:
an indicator tube having an upper portion and a lower portion, the indicator tube including a width D in the upper portion and a width d in the lower portion, the width D is greater than the width d;
a stop in the indicator tube, the stop defined by the transition from the upper portion to the lower portion of the indicator tube;
an indicator stick removably disposed within the indicator tube, the indicator stick having an upper portion including a width A and a lower portion including a width B, tile width A is greater than the width B; and
a stop in the indicator stick, the stop defined by the transition from the upper portion to the lower portion of the indicator stick,
wherein the stop of the indicator stick selectively engages the stop of the indicator tube when the indicator stick is disposed within the indicator tube,
wherein the stop in the Indicator tube and the stop in the indicator stick are proximate a fluid sump.

14. A fluid indicator assembly as in claim 13, wherein the stop in the indicator tube and the stop in the indicator stick have complimentary geometries.

15. A fluid indicator assembly as in claim 13, wherein the upper portion of the indicator stick further includes a seal, the seal does not prohibit the stop of the indicator tube from engaging the stop of the indicator stick.
